(19) United States
(12) Patent Application Publication
(10) Pub. No.: US 2013/0188712 A1
(43) Pub. Date: Jul. 25, 2013

(54) Compressed Domain Watermarking with Reduced Error Propagation

(71) Applicant: FutureWei Technologies, Inc., Plano, TX (US)

(72) Inventors: Jingteng Xue, Amherst, NY (US); Jun Tian, Belle Mead, NJ (US)

(73) Assignee: FUTUREWEI TECHNOLOGIES, INC., Plano, TX (US)

(21) Appl. No.: 13/749,107

(22) Filed: Jan. 24, 2013

Related U.S. Application Data
(60) Provisional application No. 61/590,205, filed on Jan. 24, 2012.

(51) Int. Cl. H04N 7/26

(52) U.S. Cl. CPC H04N 19/00569
USPC 375/240.15; 375/240.25; 375/240.12

(57) ABSTRACT

Error drift during compressed domain watermarking can be reduced by embedding watermarking symbols in macroblocks that have relatively low influence on pixel values of other macroblocks during video decompression. This influence may be quantified using compression influence values (CIVs), which may be computed/assigned based on prediction dependency relationships amongst the various macroblocks in a sequence of frames. To wit, high CIVs are assigned to macroblocks that heavily influence the pixel values of other macroblocks during intra-frame/inter-frame prediction, while low CIVs are assigned to macroblocks that have little influence over the pixel values of other macroblocks. Macroblocks having the lowest CIVs may be selected for embedding compressed domain watermarking bits/symbols. Alternatively, macroblocks having high CIVs may be excluded from a pool of candidate macroblocks that are eligible for carrying embedded compressed domain watermarking bits/symbols.

This application claims the benefit of U.S. Provisional Application No. 61/590,205 filed on Jan. 24, 2012 entitled “System and Method for Bit Stream Watermark Embedding,” which is incorporated herein by reference as if reproduced in its entirety.

### TECHNICAL FIELD

The present invention relates to digital watermarking, and, in particular embodiments, to techniques for compressed domain watermarking with reduced error propagation.

### BACKGROUND

Digital watermarking is a technique for inserting copy-write information into video media, and is often employed as an anti-piracy technique to combat illegal distribution of multimedia content. Watermarking can be performed in the pixel-domain or in the compressed bit-stream domain. Pixel-domain watermarking is relatively straightforward, but requires decoding and re-encoding of the video bit-stream. Comparatively, compressed domain watermarking is performed directly on the bit-stream (i.e., without decoding/re-encoding), and therefore is less processing intensive than pixel-domain watermarking.

One challenge in compressed domain watermarking is error drift, which occurs when watermarking bits/symbols embedded into one macroblock causes errors/distortion in other macroblocks by virtue of video decompression. More specifically, H.264 Advanced Video Coding (AVC) and other video compression standards implement intra-frame and inter-frame prediction to exploit spatial correlations in macroblocks within a sequence of frames, thereby achieving data-compression in the video bit-stream. Hence, pixel-values for one macroblock may be predicted/generated based on pixel-values of other macroblocks during video decompression. Consequently, error introduced into one macroblock through the embedding of compressed domain watermarking bits/symbols can bleed over into other macroblocks within the sequence of frames by virtue of inter-frame/intra-frame prediction. Accordingly, improved techniques for combatting error drift during compressed domain watermarking are desired.

### SUMMARY

Technical advantages are generally achieved, by embodiments of this disclosure which describe compressed domain watermarking with reduced error propagation.

In accordance with an embodiment, a method for reducing error drift during compressed domain watermarking is provided. In this example, the method includes receiving a sequence of frames collectively carrying macroblocks, and computing influence values for each of the macroblocks collectively carried by the sequence of frames. The influence values correspond to a degree in which a given macroblock influences pixel values of other macroblocks during video decompression. The method further includes embedding watermark symbols in macroblocks having influence values that are less than a threshold. An apparatus for performing this method is also provided.

In accordance with another embodiment, another method for reducing error propagation during compressed domain watermarking is provide. In this example, the method includes receiving a compressed bit-stream comprising a sequence of frames, determining prediction dependency relationships between macroblocks carried by the sequence of frames, and computing compression influence values (CIVs) for the macroblocks in accordance with the prediction dependency relationships. The method further includes excluding, from a pool of candidate macroblocks, macroblocks having a CIV that exceeds a threshold, and selecting macroblocks from the pool of candidate macroblocks for embedding watermark payload bits in accordance with the CIVs.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of a network for embedding digital watermarks in a bit-stream;

FIG. 2 illustrates a diagram of an embedding device configured for pixel-domain watermarking;

FIG. 3 illustrates a diagram of an embedding device configured for compressed domain watermarking;

FIG. 4 illustrates a diagram of a frame exhibiting watermark error propagation during intra-frame prediction;

FIG. 5 illustrates a diagram of a sequence of frames exhibiting watermark error propagation during inter-frame prediction;

FIG. 6 illustrates a flowchart of a method for compressed domain watermarking;

FIG. 7 illustrates a graph of prediction dependency relationships between macroblocks in a sequence of frames;

FIG. 8 illustrates a graph of prediction dependency relationships between macroblocks as weighted by compression influence;

FIG. 9 illustrates a block diagram of an embodiment communications device; and

FIG. 10 illustrates a block diagram of a computing platform.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed herein are merely illustrative of specific ways to make and use the invention, and do not limit the scope of the invention.

Disclosed herein is a compressed domain watermarking technique that minimizes error propagation by embedding watermarking symbols in macroblocks that have relatively low influence on pixel values of other macroblocks in a sequence of frames. More specifically, macroblocks in a sequence of frames are analyzed to determine their prediction dependency relationships. Thereafter, each macroblock is assigned a compression influence value (CIV) in accordance with the degree to which the macroblock influences the pixel values of other macroblocks. To wit, high CIVs are assigned to macroblocks that heavily influence the pixel values of other macroblocks, while low CIVs are assigned to macroblocks that have little influence over the pixel values of other macroblocks. Finally, compressed domain watermarking symbols are embedded in macroblocks having low CIVs to mitigate error propagation.

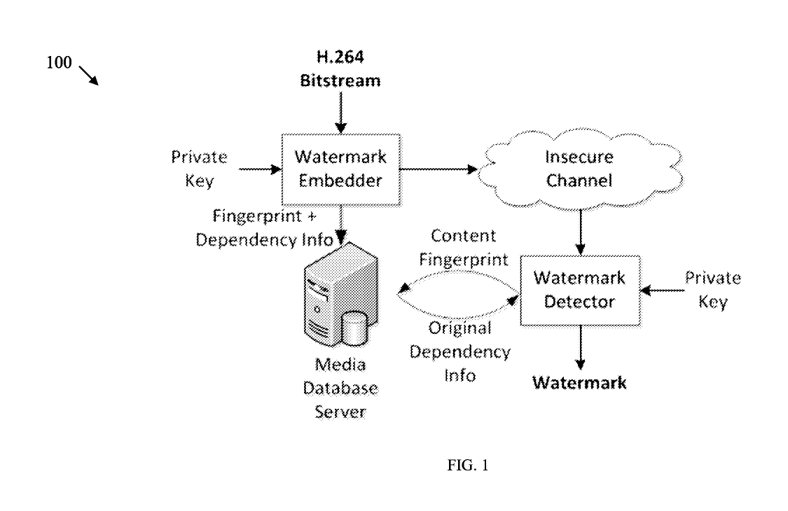

FIG. 1 illustrates a network 100 for embedding watermarks in a bit-stream. The H.264 bit-stream feeds to the watermark embedder, which extracts the necessary macroblock dependency based on encoding information (e.g., prediction mode, etc.) and selects macroblocks to embed the watermark payload bits in the compressed domain. The embedder registers the content to a media database server by uploading the dependency information and a multimedia-content, e.g., video, fingerprint of the stream. The compressed stream of the macroblock prediction information is generally very small in size. The embedded bit-stream is then transmitted to the user side, where the watermark detector calculates the fingerprint of the content and requests the media database server for its corresponding original dependency information. The detector runs an algorithm similar to the one used by the embedder to compute the locations of the embedded macroblocks and then extracts the watermark payload bits at those positions.

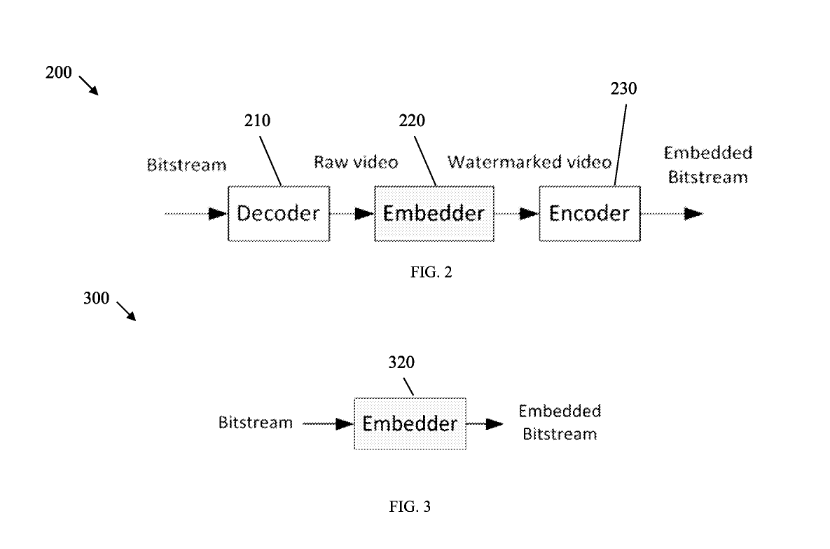

As discussed above, compressed domain watermarking is less processing intensive than pixel-domain watermarking. FIG. 2 illustrates an embedding device 200 for pixel-domain watermarking that includes a decoder 210, an embedder 220, and an encoder 230. As shown, the decoder 210 decodes a bit-stream to obtain raw video data, within which watermarking symbols/bits are embedded by the embedder 220 to generate watermarked video. The watermarked video stream is then re-encoded by the encoder 230 to obtain an embedded bit-stream. FIG. 3 illustrates an embedding device 300 for compressed domain watermarking that includes an embedder 320. As shown, the embedder 320 embeds watermarking bits directly into the bit-stream, thereby producing the embedded bit-stream. As can be seem, compressed domain watermarking is less processing intensive than pixel-domain watermarking because the bit-stream is not decoded/re-encoded.

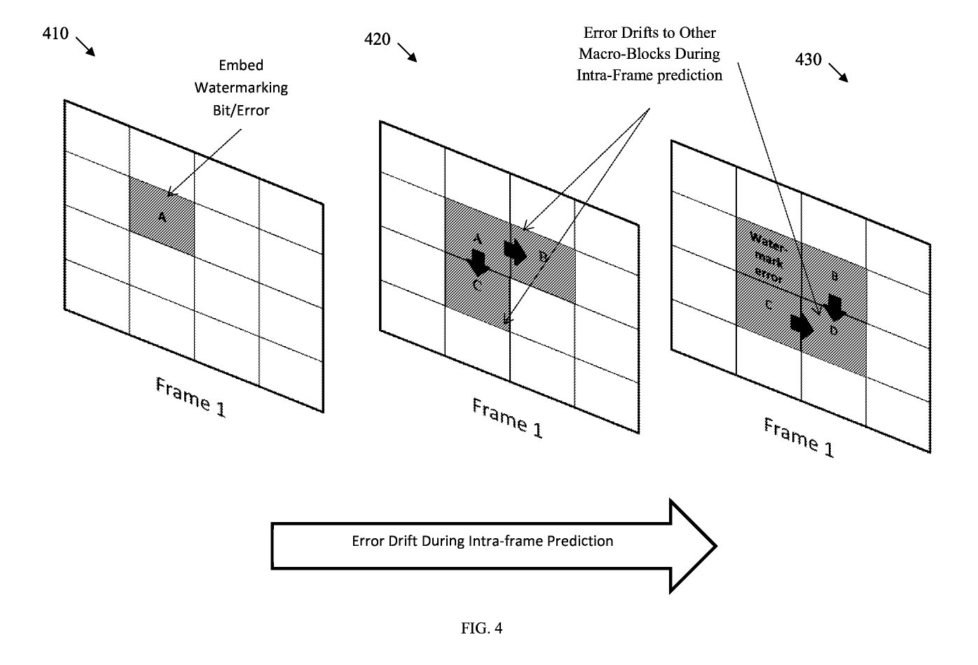

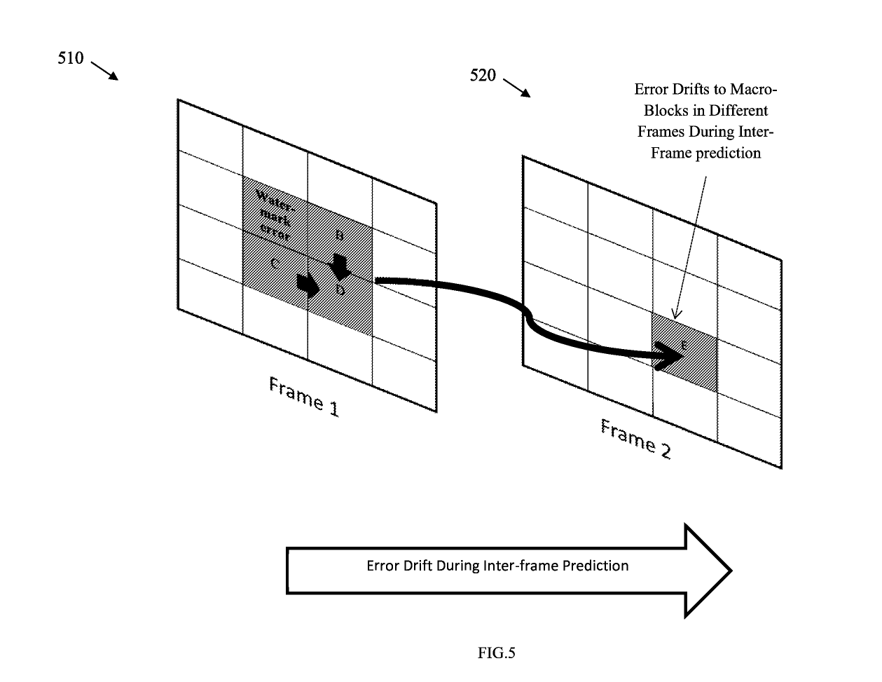

Error propagation can result from compressed domain watermarking by virtue of compression techniques that include, inter alia, intra-frame prediction and inter-frame prediction. FIG. 4 illustrates diagrams 410-430 that show how compressed domain watermarking can cause error drift in a frame (frame-1) during intra-frame prediction. As shown, a compressed domain watermarking symbol is embedded into macroblock-A of the frame-1. Embedding the compressed domain watermarking symbol modifies some of the pixel-values in the macroblock-A, which (by definition) introduces a coding error (referred to herein as ‘watermark error’) into macroblock-A. Notably, the watermark error resulting from embedding a compressed domain watermarking into selected macroblocks may result in an unperceivable reduction in image quality so long as the error does not propagate widely to surrounding macroblocks. In this case, macroblock-B and macroblock-C are generated from pixel values of macroblock-A via intra-frame prediction, and as a result the watermark error bleeds into macroblock-B and macroblock-C as shown in the frame diagram 420. Further, macroblock-D is generated from pixel values of macroblock-B and macroblock-C via intra-frame prediction, and as a result the watermark error bleeds into macroblock-D. As such, the embedding of a compressed domain watermarking symbol in macroblock A results in distortion across macroblocks A-D. FIG. 5 illustrates diagrams 510-520 showing how compressed domain watermarking can cause error drift during in a sequence of frames (frame-1, frame-2, etc.) during inter-frame prediction. As shown, macroblock-E in frame-2 is generated from pixel values of one or more of the macroblocks A-D in frame-1 via inter-frame prediction, and as a result the watermark error from frame-1 bleeds into macroblock-E of frame-2.

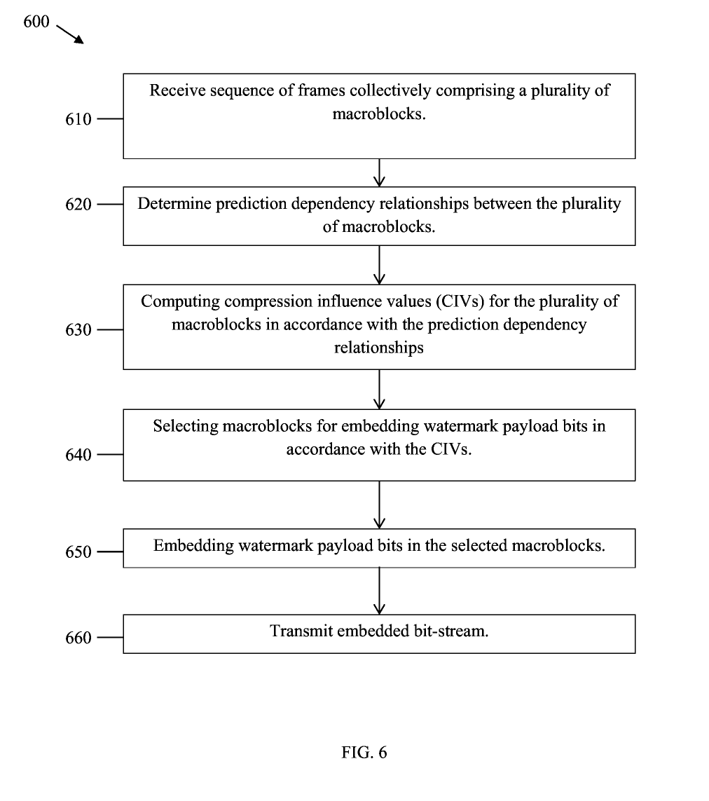

Error propagation can be mitigated by embedding watermarking symbols/bits in macroblocks that have relatively little influence on pixel values of other macroblocks in the sequence of frames. For instance, it may have been better to embed the compressed domain symbol into macroblock-E than macroblock-A (in FIGS. 4-5), as this may avoid introducing coding errors in macroblocks A-D. FIG. 6 illustrates a method 600 for compressed domain watermarking, as might be performed by an embedder (e.g., the embedder 320). The method 600 begins at step 610, where the embedder receives a sequence of frames collectively comprising a plurality of macroblocks. Next, the method 600 proceeds to step 620, where the embedder determines prediction dependency relationships between the plurality of macroblocks.

Thereafter, the method 600 proceeds to step 630, where the embedder computes compression influence values (CIVs) for the plurality of macroblocks in accordance with the prediction dependency relationships. Subsequently, the method 600 proceeds to step 640, where the embedder selects macroblocks for embedding watermark payload bits in accordance with the CIVs. More specifically, macroblocks having low CIVs may be selected for the embedding of compressed domain watermarking symbols/bits, while macroblocks having high CIVs may be excluded from those selected for the embedding of compressed domain watermarking symbols/bits. Next, the method 600 proceeds to step 650, where the embedder embeds watermark payload bits into the selected macroblocks. Finally, the method 600 proceeds to step 660, where the embedder transmits the embedded bit-stream.

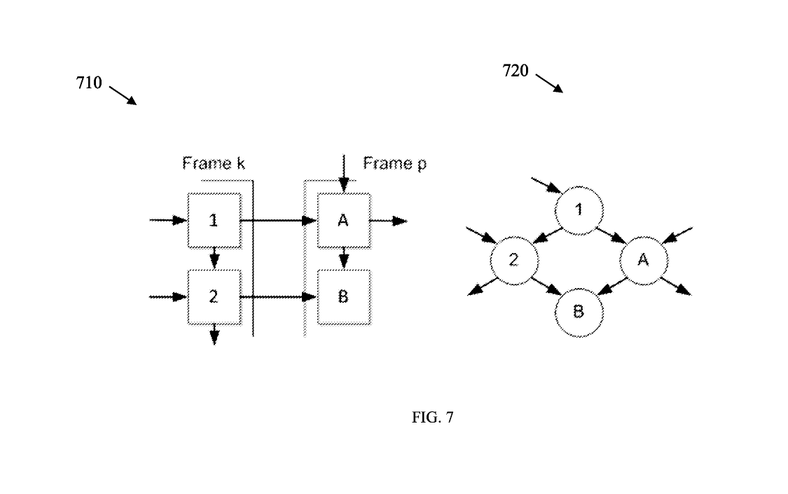

Prediction dependency relationships may be represented graphically. FIG. 7 illustrates a frame diagram 710 depicting dependency relationships between macroblocks in a frame-k and a frame-p. As shown, frame-k includes macroblock-1 and macroblock-2, while frame-p includes macroblock-A and macroblock-B. Macroblock-2 and macroblock-A are dependent on macroblock-1, while macroblock-B is dependent on macroblock-2 and macroblock-A. Accordingly, the prediction dependency relationships between macroblocks of frame-k and frame-p are represented graphically in the diagram 720.

Computing CIVs in accordance with the prediction dependency relationships can be accomplished in a variety of ways. For instance, an algorithm may be used, such as the one listed in table 1 (below):

TABLE 1
Pseudo code of the influence computing algorithm.

| 1 procedure CIV(G, r): | |
|---|---|
| 2 | empty stack s; mark r; push r into s; |
| 3 | while s is not empty |

| | |
|---|---|
| 4 | p := pop s; I(p):=I(p)+1; |
| 5 | for each outgoing node k of p |

| | |
|---|---|
| 6 | if k is unmarked |

| | |
|---|---|
| 7 | for each node t in s, I(t):=I(t)+1; |
| 8 | push p, k into s; break; |

| | |
|---|---|
| 9 | for each incoming node k of p |

| | |
|---|---|
| 10 | if k is not in s then I(k):=I(k)+I(p); |
| 11 | mark p; |

The pseudo code of this algorithm, named CIV, is listed in Table 1, in which G is the dependency graph and r stands for the root node. A table named I records the influence values for all nodes. Initially this table is set to all zeros and none of the nodes are marked. Note that G is a DAG.

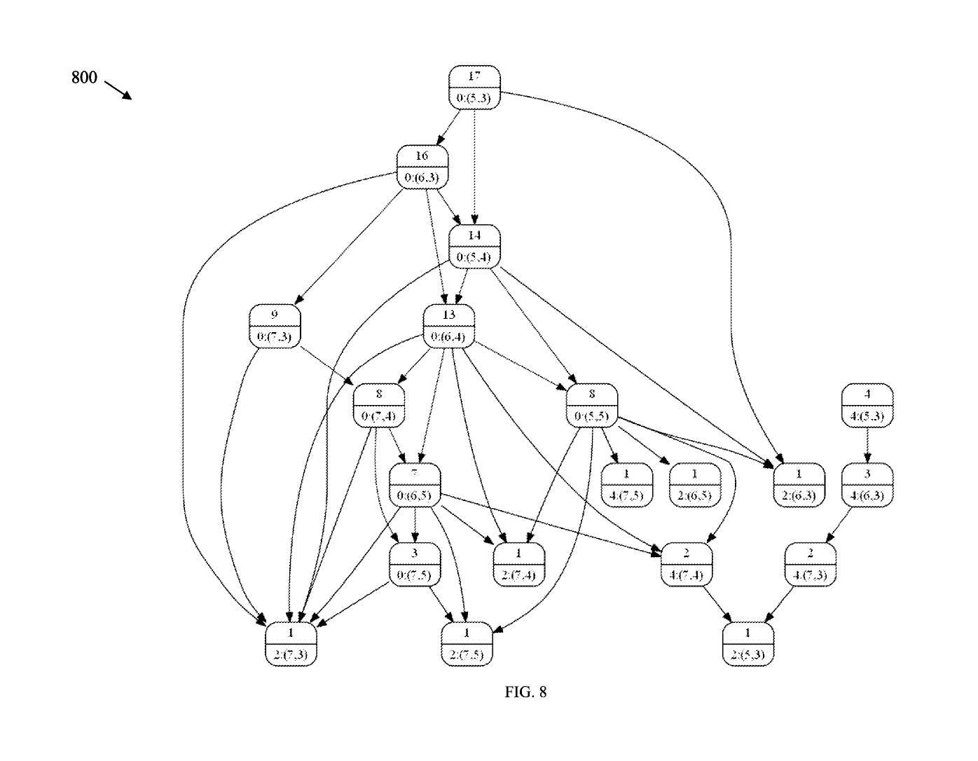

The time complexity of CIV is O(n²), where n stands for the number of nodes. After the run, the influence value of macroblock k can be easily accessed by looking up I(k), while I(root) holds the total number of graph nodes. Once CIVs are computed for the macroblocks, the macroblocks may be graphed in accordance with their weighted CIVs, as demonstrated in FIG. 8. The node label format is POC(x,y):I, where (x,y) refers to MB position, and I refers to its influence value. The topology of the graph shows that certain key macroblocks have greater impact on the overall video. Indeed, histograms of influence values obtained during simulation show that a few key influential macroblocks only take up a very small proportion. Further, simulations have shown that the visual effect of an embedding watermarking symbols in macroblocks having low influence values yield imperceptible visual artifacts.

Embodiments of this disclosure minimize error propagation during complex domain watermarking with low complexity, high fidelity, high robustness, and high security. Macroblock dependencies are first extracted from the H.264 prediction mechanism and cached as a graph. The macroblocks that have the least impact on the overall sequence are selected to embed the desired watermark. This method of embedding intrinsically minimizes the error propagation without post processing of drift compensation. Extensive simulations have been carried out to confirm that watermark embedding embodiments are able to achieve the desired performance with low complexity, high fidelity, robustness and security.

In an embodiment, a prediction dependency graph describes the dependency relationship among all macroblocks of a given set of multimedia-content, e.g., video, frames, in which each node represents a macroblock. A directed edge from one macroblock to another means that the former block is used to predict the latter block. Such dependency between the two macroblocks may be due to one or more sub-block predictions.

A node in the dependency graph may have several incoming edges and several outgoing edges. Because the picture encoding and decoding are in raster scan order, the dependency graph is a directed acyclic graph (DAG). The error of macroblock A will propagate to macroblock B if and only if there exists a path from node A to node B.

The influence of a macroblock generally is the number of macroblocks (including itself) that it links to in the dependency graph. This value indicates the impact of this macroblock to the set of frames in terms of decoding. A greater influence of one macroblock means a greater significance on fidelity since a modification on it will cause error drift to a larger extent and distort a larger portion of the multimedia-content, e.g., video.

The dependency graph is built or created and updated along with a partial decoding of H.264 bit stream. The graph structure is initialized with a virtual node, called the root in the following description. This root will link to all macroblock nodes that do not need any other macroblocks to decode. A table with a size that is equal to the total number of macroblocks within a set of frames is used to associate the graph node locations with the macroblocks for fast indexing.

Once the prediction mode of a macroblock is decoded, the incoming edges of the corresponding node can be recorded. The outgoing edges of the macroblocks used for the prediction are marked as well. The search for these parent nodes is simply a table look-up and costs O(1) time complexity. The number of incoming edges of a node is bounded by the maximal number of prediction references defined in the codec. In the case that no incoming edge is found for a node, the root will be assigned as its parent and an edge from the root to it is created.

After the embedded bit-stream is transmitted to the user side, the watermark detector calculates the fingerprint of the content and requests the media database server for its corresponding original dependency information. The detector runs an algorithm similar to the one used by the embedder to compute the locations of the embedded macroblocks and then extracts the watermark payload bits at those positions.

In an embodiment, an external database server is used to ensure the robustness of the system. Uncontrolled middle processes, attacks and possible distortions within the transmission channel may occur to the bit-stream and make it in different formats when reaching the user end. The prediction relations are likely to be changed. By keeping the original dependency information externally, an accurate match between the embedder and the detector is guaranteed.

Adding the database server to the system generally does not reduce its security. In an embodiment the database server does not needs not to encrypt the exchange messages because the concealment of the embedding positions is protected by the private key at both the embedder and the detector. Also, the content cannot be retrieved solely by the prediction mode stream.

The macroblock selection can be performed once the dependency graph and the influence values are obtained. In an embodiment, only a portion of the macroblocks are selected for embedding for the following reasons. 1) Fidelity. Embedding the macroblocks with large influence values degrades the picture visual quality due to the potential long range of error propagation. Therefore, the macroblocks with smaller influence are preferred and selected for embedding. 2) Robustness. If the error of one macroblock due to embedding propagates to another selected macroblock, then the watermark bit embedded on the latter may be unexpectedly distorted. To avoid this issue, in an embodiment a pair of macroblocks is not selected if a path in the dependency graph exists from one macroblock to another. 3) Security. In order to protect the secrecy of the embedding locations, in an embodiment the selection is scrambled by a private key. As a result, attackers cannot determine the exact locations, and any a full range distortion will dramatically degrade the content quality.

With these analyses, the block selection algorithm is derived as follows. First the skipped blocks are dropped because there is no room for modification. Then the influence table is sorted. The macroblocks are examined one by one from the smallest to the largest in terms of influence value.

For each macroblock, the prediction modes of each 4×4 sub blocks are acquired. Any sub block in another size is considered as a combination of several 4×4 blocks with the same prediction mode. The macroblock structure as represented by these 16 prediction modes is used as a public key. If the prediction modes are quantized to be presented by two bits, then the public key has a length of 32 bits. A private key is used to scramble this public key and generate a result which determines whether or not the macroblock is pre-selected.

Lastly, in an embodiment a conflict check is performed to avoid selecting any macroblocks that can be influenced by a previously selected macroblock. This step is done by a series of path searches to test the connectivity from the macroblock under checking to any previously selected macroblock. If such a path is found, the macroblock is dropped. Otherwise, it is kept. Such iteration continues until the desired watermark bit rate is reached or all macroblocks are tested.

For watermark embedding and extraction, the incoming H.264 bit-stream is first network abstraction layer (NAL) decoded to expose the picture stream, which is further entropy decoded. The prediction information is cached, used for watermark selection, and uploaded to database server.

Robustness is a consideration in designing the macroblock embedding scheme. An embodiment embeds a macroblock by changing the contrast of the DC values of its four 8×8 sub-blocks, namely D₀ D₁ D₂ D₃. If an 8×8 block consists of 4×4 blocks, then its DC value is defined to be the mean DC value of the four 4×4 sub-blocks. Let M=max{Dᵢ}0≦i<4; m=min{Dᵢ}0≦i<4, then the intra macroblock contrast c is defined as

$$c = \frac{M}{m} .$$

A threshold T can be defined. To embed 1 to a macroblock, its contrast c is made greater than T. To embed 0 to a macroblock its contrast c is changed to be smaller than T.

Similar to the embedding process, the extraction process starts with watermark macroblock selection according to the original prediction record that is downloaded from the media server. The detector owns the same private key as the embedder, therefore the selection matches. For each selected macroblock, the intra DC contrast c is computed. If c>T the watermark bit at this position is 1, and otherwise the bit is 0.

In practice, error correction codes (such as convolutional code) and spread spectrum codes can be applied to a watermark payload to ensure error-free watermark transmission.

In experiments, two standard QCIF sequences and two 1280×720p sequences were tested. Each of them has 300 frames. In order to test the fidelity and robustness with the maximal watermarking capacity, for each sequence, all macroblocks with the minimal influence value are embedded. The results show that the time for embedding and extraction is only 5% of the decoding time for the 720p contents. Table 2 shows the watermark capacity, picture quality, and the robustness of the scheme. Note that some contents carry more payloads because of their structure characteristics. Also note that the listed recovery rate is the raw bit rate (i.e., without error correction and spread spectrum) to reveal the fundamental performance of the proposed watermark system.

TABLE 2
Simulation results

| Sequence | Capacity(bps) | PSNR(dB) | Recovery Rate |
|---|---|---|---|
| Foreman | 399.9 | 45.9 | 99.77% |
| Tempete | 3322.8 | 58.1 | 99.98% |
| Raven | 1077 | 52.7 | 99.9% |
| Flower | 270.3 | 53.5 | 99.78% |

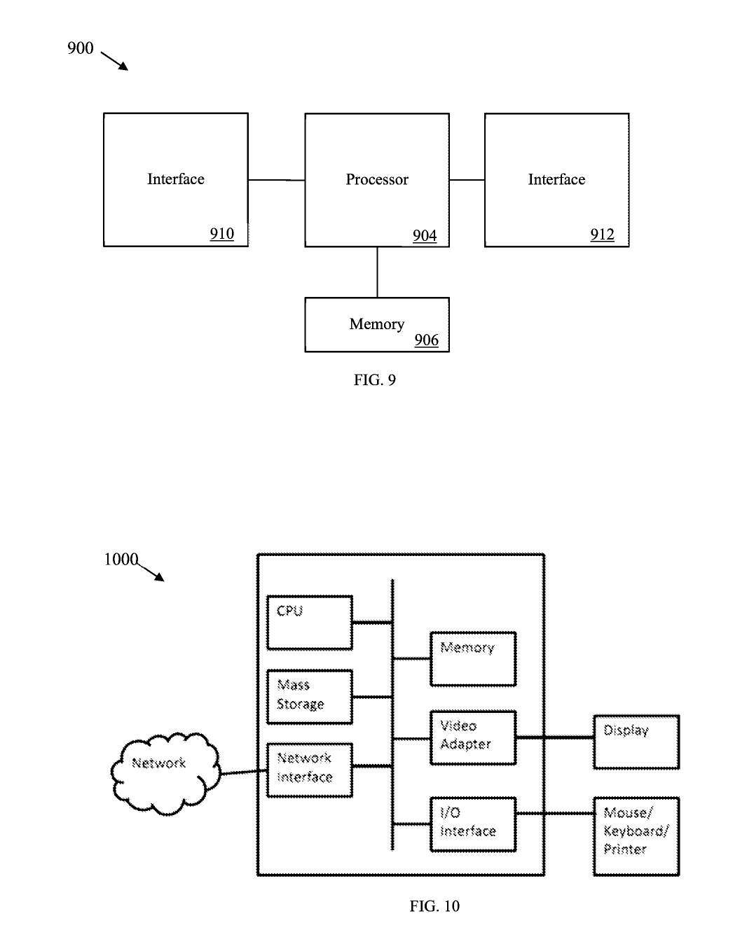

FIG. 9 illustrates a block diagram of an embodiment of a device 900, that may be used to embed compressed domain watermarking symbols/bits in accordance with aspects of this disclosure. The device 900 may include a processor 904, a memory 906, and a plurality of interfaces 910-912, which may (or may not) be arranged as shown in FIG. 9. The processor 904 may be any component capable of performing computations and/or other processing related tasks, and the memory 906 may be any component capable of storing programming and/or instructions for the processor 904. The interfaces 910-912 may be any component or collection of components that allows the device 900 to communicate with other device and/or to transit/receive data bit-streams (compressed, embedded, or otherwise).

FIG. 10 is a block diagram showing internal components of a processing system that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus. The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs. The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not shown) may be used to provide a serial interface for a printer. The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

The following references are related to this disclosure, and are incorporated herein by reference in its entirety: (i) D. Simitopoulos, S. A. Tsaftaris, N. V. Boulgouris, and M. G. Strintzis, “Compressed-domain Video Watermarking of MPEG streams,” Multimedia and Expo, IEEE International Conference on, Vol. 1, pp. 569-572, 2002; (ii) M. Noorkami, and R. M. Mersereau, “Compressed-domain Video Watermarking for H.264,” Image Processing, IEEE International Conference on, Vol. 2, September 2005; (iii) A. Mansouri, A. M. Aznaveh, F. Torkamani-Azar, and F. Kurugollu, “A Low Complexity Video Watermarking in H.264 Com-pressed Domain,” Information Forensics and Security, IEEE Transactions on, Vol.5, No. 4, December 2010; (iv) P. Nguyen, A. Beghdadi, and M. Luong, “Perceptual Water-marking Using Pyramidal JND Maps,” Multimedia, IEEE International Symposium on, pp. 418-423, December 2008 (v) W. Huo, Y. Zhu, and H. Chen, “A Controllable Error-Drift Elimination Scheme for Watermarking Algorithm in H.264/AVC Stream,” Signal Processing Letters, IEEE, Vol. 18, No. 9, pp.535-538, September 2011; (vi) S. Lee, and D.Y. Chang, “Robust Video Fingerprinting for Content-Based Video Identification”, Circuits and Systems for Video Technology, IEEE Transactions on, Vol. 18, No. 7, July 2008.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

We claim:

1. A method for reducing error drift during compressed domain watermarking, the method comprising:
receiving a sequence of frames collectively carrying a plurality of macroblocks;
computing influence values for each of the plurality of macroblocks, the influence values corresponding to a degree in which a given macroblock influences pixel values of other macroblocks in the plurality of macroblocks during video decompression; and
embedding watermark symbols in macroblocks having influence values that are less than a threshold.

2. The method of claim 1, wherein the influence values correspond to degrees in which a given macroblock influences pixel values of other macroblocks in the plurality of macroblocks during intra-frame prediction.

3. The method of claim 1, wherein the influence values correspond to degrees in which a given macroblock influences pixel values of other macroblocks in the plurality of macroblocks during inter-frame prediction.

4. The method of claim 1, wherein the influence values correspond to degrees in which a given macroblock influences pixel values of other macroblocks in the plurality of macroblocks during intra-frame prediction and inter-frame prediction.

5. The method of claim 1, wherein computing influence values for each of the plurality of macroblocks comprises:
determining prediction dependency relationships between the plurality of macroblocks; and
computing the influence values in accordance with the prediction dependency relationships.

6. The method of claim 5, wherein the prediction dependency relationships between the plurality of macroblocks specify which macroblocks are used to predict the pixel values of other macroblocks during intra-frame prediction and inter-frame prediction.

7. The method of claim 5, wherein the influence values are compression influence values (CIVs).

8. The method of claim 7, wherein the computing CIVs in accordance with the prediction dependency relationships comprises:
computing the CIVs in accordance with the following algorithm:

| 1 procedure CIV(G, r): | |
|---|---|
| 2 | empty stack s; mark r; push r into s; |
| 3 | while s is not empty |
| | |
|---|---|
| 4 | p := pop s; I(p):=I(p)+1; |
| 5 | for each outgoing node k of p |
| | |
|---|---|
| 6 | if k is unmarked |
| | |
|---|---|
| 7 | for each node t in s, I(t):=I(t)+1; |
| 8 | push p, k into s; break; |
| | |
|---|---|
| 9 | for each incoming node k of p |
| | |
|---|---|
| 10 | if k is not in s then I(k):=I(k)+I(p); |
| 11 | mark p. |

9. The method of claim 1, wherein embedding watermark symbols in macroblocks comprises:
embedding compressed domain watermark symbols in a compressed media bit-stream carrying the sequence of frames.

10. An apparatus for embedding compressed domain watermarking symbols, the apparatus comprising:
a processor; and
a computer readable storage medium storing programming for execution by the processor, the programming including instructions to:
receive a sequence of frames collectively carrying a plurality of macroblocks;
compute influence values for each of the plurality of macroblocks, the influence values corresponding to a degree in which a given macroblock influences pixel values of other macroblocks in the plurality of macroblocks during video decompression; and
embed watermark symbols in macroblocks having influence values that are less than a threshold.

11. The apparatus of claim 10, wherein the influence values correspond to degrees in which a given macroblock influences pixel values of other macroblocks in the plurality of macroblocks during intra-frame prediction and inter-frame prediction.

12. The apparatus of claim 10, wherein the instructions to compute influence values for each of the plurality of macroblocks includes instructions to:
determine prediction dependency relationships between the plurality of macroblocks; and
compute the influence values in accordance with the prediction dependency relationships.

13. The apparatus of claim 12, wherein the prediction dependency relationships between the plurality of macroblocks specify which macroblocks are used to predict the pixel values of other macroblocks during intra-frame prediction and inter-frame prediction.

14. The apparatus of claim 13, wherein the influence values are compression influence values (CIVs).

15. The apparatus of claim 14, wherein the instructions to compute the CIVs in accordance with the prediction dependency relationships includes instructions to:
compute the CIVs in accordance with the following algorithm:

| 1 procedure CIV(G, r): | |
|---|---|
| 2 | empty stack s; mark r; push r into s; |
| 3 | while s is not empty |
| | |
|---|---|
| 4 | p := pop s; I(p):=I(p)+1; |
| 5 | for each outgoing node k of p |
| | |
|---|---|
| 6 | if k is unmarked |
| | |
|---|---|
| 7 | for each node t in s, I(t):=I(t)+1; |
| 8 | push p, k into s; break; |
| | |
|---|---|
| 9 | for each incoming node k of p |
| | |
|---|---|
| 10 | if k is not in s then I(k):=I(k)+I(p); |
| 11 | mark p. |

16. The apparatus of claim 10, wherein the instructions to embed watermark symbols in macroblocks includes instructions to:
embed compressed domain watermark symbols in a compressed media bit-stream carrying the sequence of frames.

17. A method for reducing error propagation during compressed domain watermarking, the method comprising:
receiving a compressed bit-stream comprising a sequence of frames;
determining prediction dependency relationships between a plurality of macroblocks carried by the sequence of frames;
computing compression influence values (CIVs) for each of the plurality of macroblocks in accordance with the prediction dependency relationships;
excluding, from a pool of candidate macroblocks, macroblocks in the plurality of macroblocks having a CIV that exceeds a threshold; and
selecting macroblocks from the pool of candidate macroblocks for embedding watermark payload bits.

18. The method of claim 17, wherein the CIVs correspond to degrees in which a given macroblock influences pixel values of other macroblocks in the plurality of macroblocks during intra-frame prediction and inter-frame prediction.

19. The method of claim 17, wherein the prediction dependency relationships between the plurality of macroblocks specify which macroblocks are used to predict the pixel values of other macroblocks during intra-frame prediction and inter-frame prediction.

20. The method of claim 17 further comprising embedding compressed domain watermarking symbols in the compressed bit stream by embedding compressed domain watermarking symbols in the selected macroblocks.
